(19) United States
(12) Patent Application Publication
(10) Pub. No.: US 2011/0265657 A1
(43) Pub. Date: Nov. 3, 2011

(54) INFUSION ASSEMBLY FOR A MACHINE FOR THE PREPARATION OF BEVERAGES

(75) Inventor: Danilo Icardi, Torino (IT)

(73) Assignee: LUIGI LAVAZZA S.P.A., TORINO (IT)

(21) Appl. No.: 13/142,795

(22) PCT Filed: Dec. 29, 2009
(86) PCT No.: PCT/IB2009/055975

§ 371 Date: Jun. 29, 2011

(30) Foreign Application Priority Data
Dec. 30, 2008 (IT) TO2008A001008

(51) Int. Cl. A47J 31/40

(52) U.S. Cl. 99/280

(57) ABSTRACT

An infusion assembly for a machine for the preparation of beverages, including an abutment member and a receiving member which are capable of assuming, in a stationary support and guide structure, a spaced opening position as well as an engaged closing position in which they define an infusion chamber. The relative movement of said members is controlled by an electric linear actuator. The receiving member has a first body which is mounted movable in the support and guide structure towards and away from the abutment member, and a second body, which can be engaged with and disengaged from the first body and in which a cavity is formed, which cavity cooperates so as to define the infusion chamber and can be provided internally with a plurality of perforated needles capable of piercing a wall of a capsule.

### BACKGROUND OF THE INVENTION

The present invention relates to an infusion assembly for a machine for the preparation of beverages, in particular coffee.

More specifically the invention relates to an infusion assembly comprising a support and guide structure which is stationary during operation and carries an abutment member and an associated hollow receiving member, the receiving member being able to receive an amount or dose of a substance, possibly pre-packaged in a capsule or the like, for the preparation of a beverage; said members being able to assume a relative closing position in which they are coupled with one another in a fluid-tight manner so as to define an infusion chamber, and a spaced opening position; the abutment member being provided with means for allowing the injection of water and/or steam into the infusion chamber; electrically controlled actuating means being provided for causing relative displacement of said members between the opening and closing positions.

One object of the present invention is to propose such an improved dispensing assembly.

### SUMMARY OF THE INVENTION

This object, together with others, is achieved according to the invention by an infusion assembly of the type described above, characterized in that the receiving member comprises
a first body which is mounted movable in said support and guide structure towards and away from the abutment member, and
a second body, which can be engaged with and disengaged from the first body and in which a cavity is formed, which cavity cooperates so as to define the infusion chamber and can be provided internally with a plurality of perforated needles capable of piercing a wall of a capsule.

In one embodiment said second body has a gripping member able to be manually gripped for engagement/disengagement of the first body with/from the second body.

According to a further characteristic feature one of said members is provided with a radially protruding annular sealing element and in the closed position one of said members partially penetrates inside the other one such that said annular sealing element forms an essentially radial seal between them.

### BRIEF DESCRIPTION OF THE DRAWINGS

Further characteristic features and advantages of the invention will become clear from the following detailed description provided purely by way of a non-limiting example, with reference to the accompanying drawings in which:

FIG. 1 is a perspective view of an infusion assembly according to the present invention; and

FIGS. 2 and 3 are partial perspective views of a member for receiving an infusion assembly according to the invention in which the infusion chamber can be separated and removed.

### DETAILED DESCRIPTION OF THE INVENTION

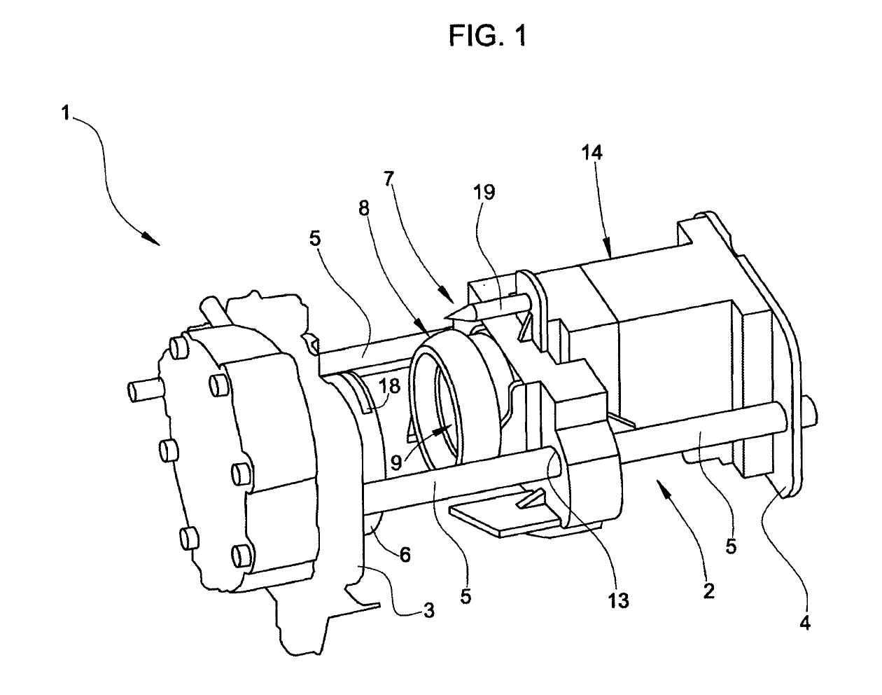

In FIG. 1 an infusion assembly according to the invention for a machine for the preparation of beverages, in particular hot beverages, such as coffee, is denoted overall by 1.

The infusion assembly 1 is intended to be mounted in a machine for the preparation of beverages of the type known per se and therefore not illustrated.

In the present description and in the accompanying drawings an infusion assembly 1 for a machine operating with capsules is described, but the invention is also applicable to the infusion assemblies in which a dose of loose substance, i.e. not pre-packaged in capsules, pods or the like, is used.

In the example of embodiment shown, the infusion assembly 1 comprises a support and guide structure 2 which is stationary during operation and comprises two end plates 3 and 4 facing each and interconnected by means of a pair of parallel rods 5 which are preferably cylindrical.

The structure 2 supports an abutment member 6 and an associated hollow receiving member 7 which are facing each other.

The receiving member 7 comprises a body 8 in which there is defined a cavity 9 able to receive a dose of substance for the preparation of the beverage, in particular a capsule or pod such as that described in the international patent application WO2008/015642 in the name of the same Applicant.

The abutment member 6 is connected to the plate 3, while the receiving member 7 is mounted displaceable along the rods 5 towards and away from the abutment member 6. For this purpose the receiving member 7 is provided with two parallel through-holes 13 inside which the interconnecting and guiding rods 5 extend.

The displacement of the receiving member 7 relative to the abutment member 6 may be conveniently controlled by an electric linear actuating device denoted overall by 14 in FIG. 1.

The members 6 and 7 are in particular able to assume a spaced relative opening position, shown in FIG. 1, where a capsule introduced into the machine may be arranged between said members 6 and 7 where for example it is held by means of a retaining device with pivotable jaws. Activation of the actuator 14 is then able to displace the receiving member 7 towards the abutment member 6 until a relative closing position is reached.

In the closing position the members 6 and 7 are coupled with one another in a fluid-tight manner and define an infusion chamber inside which the capsule used for preparation of the beverage is retained.

The abutment member 6 in a manner known per se has at least one duct communicating with channels in associated piercing needles (not visible in the drawings) which in the abovementioned closing condition pass through the lid of the capsule gripped inside the infusion chamber, so as to allow the injection of a flow of water and/or steam inside said capsule.

Conveniently, the abutment member 6 is provided externally with a radially projecting annular sealing element 18. In the closing condition the end of the abutment member 6 penetrates into the body 8 of the receiving member 7 such that the sealing element 18 is radially compressed inside the inlet mouth of the body 8, forming there, advantageously, an essentially radial seal.

With reference to FIG. 1, the receiving member conveniently has a longitudinal centring pin 19 which is intended to be introduced inside a corresponding opening or seat of the abutment member 6 in the closing position.

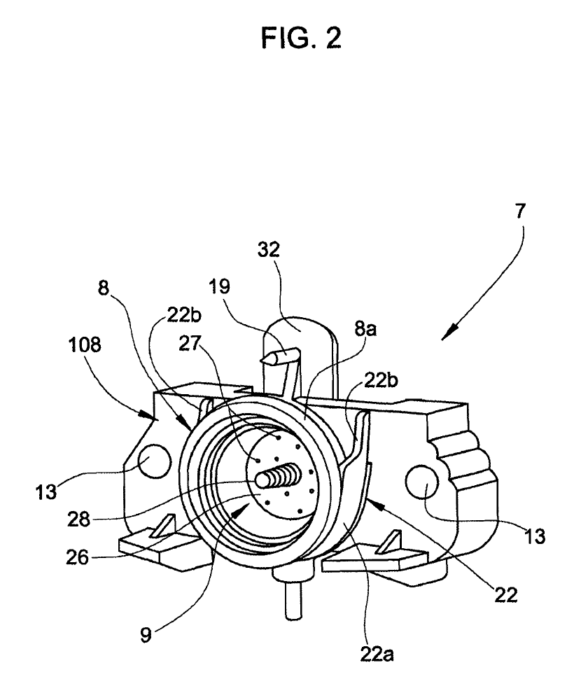

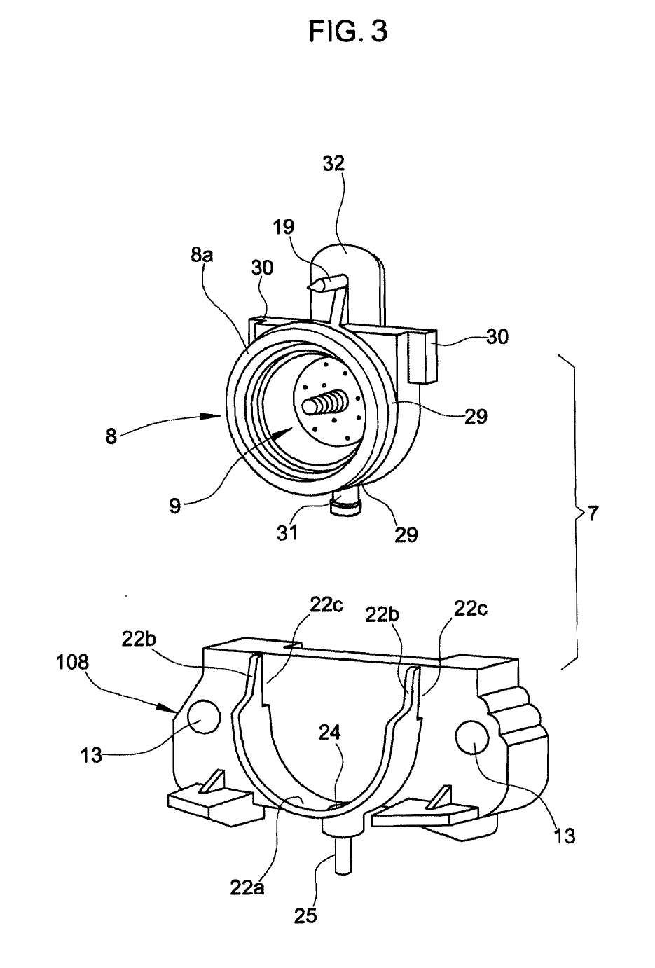

FIGS. 2 to 3 show an advantageous embodiment of the receiving member 7.

The receiving member 7 is composed of two main bodies 8 and 108 which are different from each other and can be coupled together and separated from each other (see in particular FIG. 3).

The body 108 is mounted slidable along the interconnecting and guiding rods 5 and has at the front a retaining formation 22 in the form of a projecting strip which is essentially U-shaped, having a bottom part 22a which is semicircular and top ends 22b which are spaced from the front side of the body 108 so as to define corresponding slotted seats 22c.

An opening 24 (FIG. 3) communicating with a bottom spout 25 for dispensing the beverage is formed in the lowest part of the formation 22.

The body 8 forms the cavity 9 which has, mounted therein, an end plate 26 provided with perforated piercing needles 27 intended to penetrate through the end wall of a capsule so as to allow extraction of the beverage. An expulsion spring 28, intended to perform ejection, from the cavity 9, of the used capsules, is associated with the plate 26.

The body 8 has a front collar 8a behind which there is defined an annular groove 29 inside which the bottom semi-circular portion 22a of the formation 22 of the body 108 engages when said bodies 8,108 are coupled together. The body 8 also has a pair of opposite lateral lugs 30 (FIG. 3) which are able to engage inside the slotted seats 22c of the body 108. An outflow opening communicating with an outlet nozzle 31 (FIG. 3) intended to engage inside the opening 24 of the body 108 is formed in the lowest part of the cavity 9 of the body 8.

At the top the body 8 forms a gripping lug 32 which is directed upwards and intended to be gripped by a user who wishes to disengage the body 8 from the body 108 so as to remove the body 8 from the machine inside which the assembly 1 is incorporated.

The possibility of being able to remove the body 8 is particularly advantageous for allowing easy periodic cleaning of the cavity or chamber 9 and the associated needles 27.

Engagement again of the body 8 with the body 108 is likewise extremely quick and easy.

Obviously, without affecting the principle of the invention, the embodiments and the constructional details may be significantly modified with respect to that described and illustrated purely by way of a non-limiting example, without thereby departing from the scope of the invention as defined in the accompanying claims.

1.-5. (canceled)

6. Infusion assembly (1) for a machine for the preparation of beverages, in particular coffee, comprising a support and guide structure (2) which is stationary during operation and carries an abutment member (6) and an associated hollow receiving member (7), the receiving member (7) being able to receive an amount or dose of a substance, possibly pre-packaged in a capsule or the like, for the preparation of a beverage; said members (6,7) being able to assume a relative closing position in which they are coupled with one another in a fluid-tight manner so as to define an infusion chamber, and a spaced opening position; the abutment member (6) being provided with means (16) for allowing the injection of water and/or steam into the infusion chamber (15); electrically controlled actuator means (14) being provided for causing relative displacement of said members (6, 7) between the opening and closing positions;
wherein the receiving member (7) comprises:
a first body (108) which is mounted movable in said support and guide structure (2) towards and away from the abutment member (6), and
a second body (8), which can be engaged with and disengaged from the first body (108) and in which a cavity (9) is formed, which cavity cooperates so as to define the infusion chamber and can be provided internally with a plurality of perforated needles (27) capable of piercing a wall of a capsule;
characterized in that
said first and second bodies (108, 8) are mutually engageable such that they are jointly movable throughout the relative displacement of the receiving member (7) between said opening and closing positions, said second body (8) being engageable with and disengageable from the first body (108) transversely to the coupling direction of said members (6, 7).

7. Infusion assembly according to claim 6, wherein one (6) of said members (6,7) is provided with a radially protruding annular sealing element (18) and wherein in the closed position one (7) of said members (6,7) partially penetrates inside the other one (6) such that said annular sealing element (18) forms an essentially radial seal between them.

8. Infusion assembly according to claim 7, wherein said annular sealing element (18) is mounted on the outside of the abutment member (6).

9. Infusion assembly according to claim 6, wherein said second body (8) has a gripping member (32) able to be manually gripped for engagement/disengagement of the first body (8) with/from the second body (108).

10. Infusion assembly according to claim 6, wherein said actuator means comprise an electric linear actuating device (14) connected to said support and guide structure (2) and capable of causing back and forth movements of one (7) of said members (6,7) and in particular of the receiving member (7), with respect to the other member (6), along a straight path.
